(19) United States
(12) Patent Application Publication
(10) Pub. No.: US 2014/0292596 A1
(43) Pub. Date: Oct. 2, 2014

(54) ANTENNA STRUCTURE

(71) Applicant: CHIUN MAI COMMUNICATION SYSTEMS, INC., NEW TAIPEI (TW)

(72) Inventors: CHANG-HSIN OU, New Taipei (TW); HSI-CHIEH CHEN, New Taipei (TW); CHO-KANG HSU, New Taipei (TW)

(73) Assignee: CHIUN MAI COMMUNICATION SYSTEMS, INC., New Taipei (TW)

(21) Appl. No.: 14/019,761

(22) Filed: Sep. 6, 2013

(30) Foreign Application Priority Data
Mar. 27, 2013 (TW) 102110827

(51) Int. Cl. H01Q 5/00

(52) U.S. Cl. CPC H01Q 5/0027
USPC 343/722

(57) ABSTRACT

An antenna structure includes a circuit board and an antenna formed on the circuit board. The antenna includes a ground portion and a feed portion extended from the ground portion and defining a cut with the ground portion, a connecting portion, a first resonation portion, and a second resonation portion. The first resonation portion defines a first gap with the connecting portion and the feed portion and obtains a first working frequency band by adjusting dimensions of the first resonation gap and the cut. The second resonation portion defines a second gap with the connecting portion and the ground portion, and obtains a second working frequency band by adjusting dimensions of the second resonation gap.

### BACKGROUND

1. Technical Field

The disclosure generally relates to antenna structures, and particularly to a dual band antenna structure which can support a Bluetooth function and a WiFi function.

2. Description of Related Art

Wireless communication devices such as mobile phones often include multiple functions such as a Bluetooth function and a WiFi function. Accordingly, an antenna structure which can support the Bluetooth function and the WiFi function is required in the wireless communication device.

The wireless communication devices tend to be thin and miniaturized, and the antenna structure is designed to occupy less space. However, to manufacture an antenna structure that is compact and can support both the Bluetooth and WiFi functions can be costly.

Therefore, there is room for improvement within the art.

### BRIEF DESCRIPTION OF THE DRAWINGS

Many aspects of the present disclosure can be better understood with reference to the following drawings. The components in the drawings are not necessarily drawn to scale, the emphasis instead being placed upon clearly illustrating the principles of the disclosure.

FIG. 1 is a schematic view of an antenna structure, according to an exemplary embodiment of the disclosure.

FIG. 2 is a diagram showing return loss measurement of the antenna structure shown in FIG. 1.

FIG. 3 is a diagram showing voltage standing wave ratio of the antenna structure shown in FIG. 1.

### DETAILED DESCRIPTION

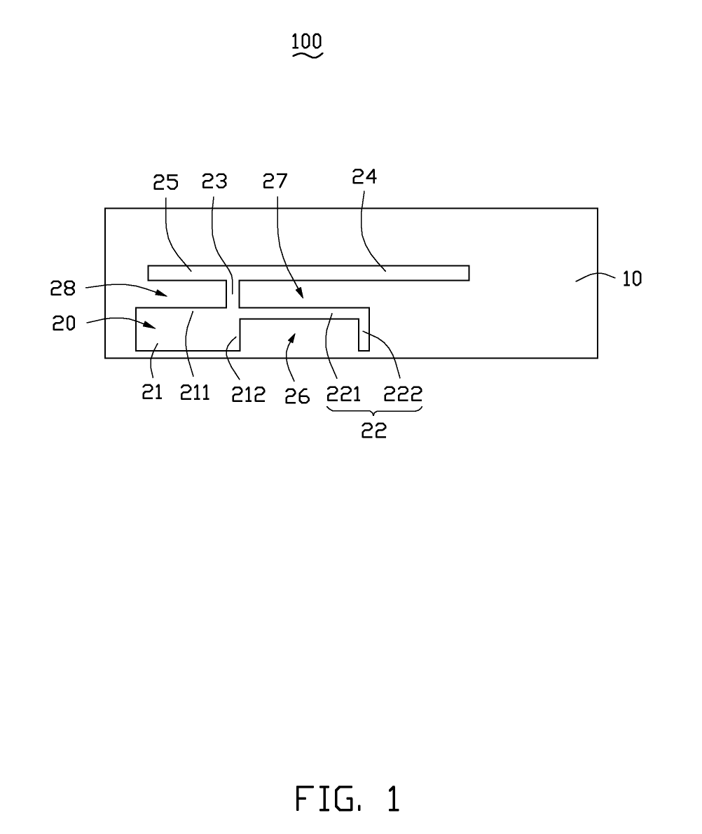

FIG. 1 is a schematic view of an antenna structure 100, according to an exemplary embodiment of the disclosure. The antenna structure 100 can be used in a wireless communication device (not shown) such as a mobile phone, a personal digital assistant, and so on, configured for transmitting and receiving signals.

The antenna structure 100 includes a circuit board 10 and an antenna 20. The circuit board 10 is a main board of the wireless communication device. The antenna 20 is formed on the circuit board 10 by printing. Therefore, the manufacture process of the antenna structure 100 is simple and cost in low.

The antenna 20 includes a ground portion 21, a feed portion 22, a connecting portion 23, a first resonation portion 24, and a second resonation portion 25.

The feed portion 22 extends from the ground portion 21 and defines a cut 26 with the ground portion 21. The first resonation portion 24 and the second resonation portion 25 are connected to the ground portion 21 and the feed portion 22 by the connecting portion 23. The first resonation portion 24 defines a first gap 27 with the connecting portion 23 and the feed portion 22. The second resonation portion 25 defines a second gap 28 with the connecting portion 23 and the ground portion 21. The first resonation portion 24, the cut 26, and the first gap 27 resonate to obtain a first working frequency band. The second resonation portion 25 and the second gap 28 resonate to obtain a second working frequency band.

The ground portion 21 is substantially rectangular and includes two opposite first edges 211 and two opposite second edges 212 shorter than the first edges 211.

The feed portion 22 is substantially L-shaped and includes an extending section 221 and a feed end 222. The extending section 221 is formed by extending from one of the second edges 212 for a first distance. The feed end 222 is formed by extending from a distal end of the extending section 221 along a direction perpendicular to the extending section 221 for a second distance and parallel to the second edges 212. The feed end 222 is configured to electrically connect to a signal feed point (not shown) of the main board and provide signals for the first resonation section 24 and the second resonation section 25.

The connecting portion 23 is substantially strip-shaped and formed by perpendicularly extending from the first edge 211 for a third distance, and configured to connect the first resonation portion 24 and the second resonation portion 25 to the ground portion 21 and the ground portion 22.

The first resonation portion 24 and the second resonation portion 25 are substantially strip-shaped and perpendicularly extended from a distal end of the connecting portion 23 along two opposite directions. A length of the first resonation portion 24 is slight longer than a length of the second resonation portion 25. The first resonation portion 24 is parallel to the extending section 221 and forms the first gap 27 with the extending section 221 and the connecting portion 23.

Dimensions of the cut 26 and the first gap 27 can be changed to adjust an electrical length of the first resonation portion 24 so that the first working frequency band can be adjusted. The second resonation portion 25 is parallel to the first edges 211 and forms the second gap 28 with one of the first edges 211 and the connecting portion 23. Dimensions of the second gap 28 can be changed to adjust an electrical length of the second resonation portion 25 so that the second working frequency band can be adjusted.

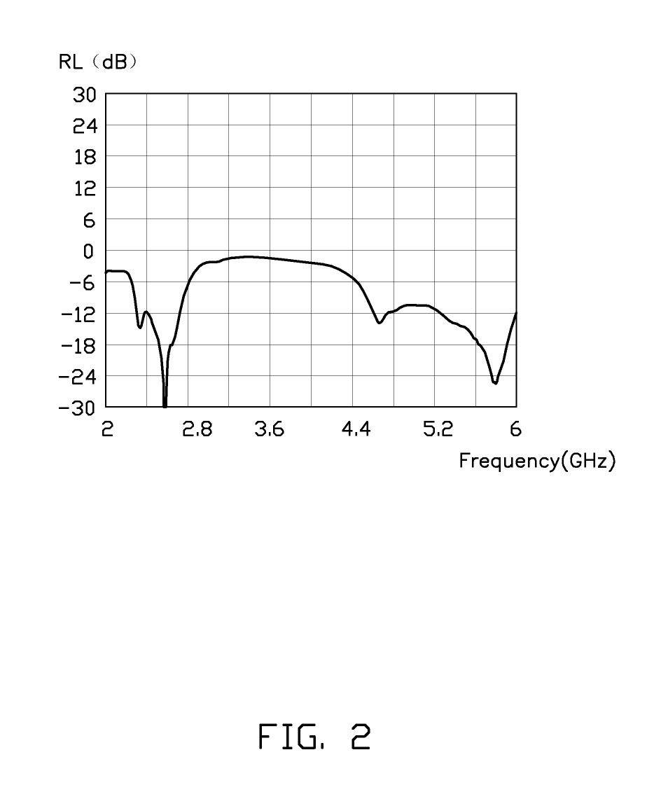

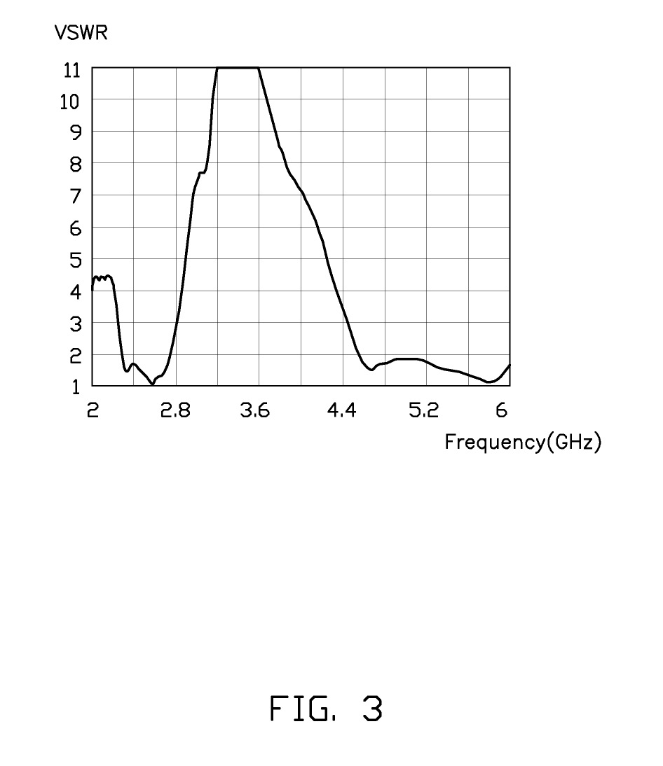

Referring to FIGS. 2 and 3, the antenna structure 100 can obtain the first working frequency band and the second working frequency band having central frequencies of about 2.4 GHz and 5 GHz which can support Bluetooth and WiFi functions, respectively.

Referring to table 1, which shows gains and efficiencies of the antenna structure 100 at different working frequencies. As shown in table 1, the antenna structure 100 can obtain better gains and efficiencies at the working frequencies in the vicinity of 2.4 GHz and 5 GHz and can satisfies radiation requirements.

TABLE 1

| Working frequency | Gain (dB) | Efficiency (%) |
|---|---|---|
| 2400 | −3.441 | 45% |
| 2420 | −2.981 | 50% |
| 2440 | −2.820 | 52% |
| 2460 | −2.677 | 54% |
| 2480 | −2.830 | 52% |
| 5185 | −3.511 | 45% |
| 5300 | −3.464 | 45% |
| 5250 | −2.491 | 56% |
| 5500 | −2.524 | 56% |
| 5550 | −2.989 | 50% |
| 5700 | −2.871 | 52% |
| 5800 | −2.922 | 51% |

The antenna 20 is directly formed on the circuit board 10 so that the antenna structure 100 occupies less space and also costs less. In addition, the antenna structure 100 obtains the first working frequency band having the central frequency at 2.4 GHz by the resonation of the first resonation portion 24, the cut 26, and the first gap 27 and obtains the second working frequency band having the central frequency at 5 GHz by the resonation of the second resonation portion 25 and the second gap 28.

It is believed that the exemplary embodiments and their advantages will be understood from the foregoing description, and it will be apparent that various changes may be made thereto without departing from the spirit and scope of the disclosure or sacrificing all of its material advantages, the examples hereinbefore described merely being preferred or exemplary embodiments of the disclosure.

What is claimed is:

1. An antenna structure, comprising:
a circuit board; and
an antenna formed on the circuit board, the antenna comprising:
a ground portion;
a feed portion extended from the ground portion and defining a cut with the ground portion;
a connecting portion;
a first resonation portion, the first resonation portion defining a first gap with the connecting portion and the feed portion, and obtaining a first working frequency band by adjusting dimensions of the first resonation gap and the cut; and
a second resonation portion, the second resonation portion defining a second gap with the connecting portion and the ground portion, and obtaining a second working frequency band by adjusting dimensions of the second resonation gap.

2. The antenna structure of claim 1, wherein the ground portion comprises two opposite first edges and two opposite second edges, the feed portion extends from one of the second edges.

3. The antenna structure of claim 2, wherein the feed portion comprises an extending section and a feed end, the extending section is formed by extending from one of the second edges for a first distance, the feed end is formed by extending from a distal end of the extending section along a direction perpendicular to the extending section for a second distance and parallel to the second edges.

4. The antenna structure of claim 3, wherein the connecting portion is formed by perpendicularly extending from one of the first edges for a third distance, the first resonation portion and the second resonation portion are connected to the ground portion and the ground portion by the connecting portion.

5. The antenna structure of claim 4, wherein the first resonation portion and the second resonation portion are substantially strip-shaped and perpendicularly extended from a distal end of the connecting portion along two opposite directions.

6. The antenna structure of claim 5, wherein the first resonation portion, the connecting portion and the extending section define the first gap.

7. The antenna structure of claim 2, wherein the second resonation portion, the connecting portion and one of the first edges define the second gap.

8. An antenna structure, comprising:
a circuit board; and
an antenna formed on the circuit board, the antenna comprising:
a ground portion comprising two opposite first edges and two opposite second edges;
a feed portion extended from one of the second edges and defining a cut with the ground portion;
a connecting portion extended from one of the first edges;
a first resonation portion; and
a second resonation portion collinear with the first resonation portion; the first resonation portion and the second resonation connected to the connecting portion; the first resonation portion, the connecting portion, and a portion of the feed portion orderly connected to form a first gap; the second resonation portion, the connecting portion, and the one of first edges orderly connected to form a second gap.

9. The antenna structure of claim 8, wherein the first resonation portion obtains a first working frequency band by adjusting dimensions of the first resonation gap and the cut; the second resonation portion obtains a second working frequency band by adjusting dimensions of the second resonation gap.

10. The antenna structure of claim 9, wherein the feed portion comprises an extending section and a feed end, the extending section is formed by extending from one of the second edges for a first distance, the feed end is formed by extending from a distal end of the extending section along a direction perpendicular to the extending section for a second distance and parallel to the second edges.

11. The antenna structure of claim 10, wherein the connecting portion is formed by perpendicularly extending from one of the first edges for a third distance, the first resonation portion and the second resonation portion are connected to the ground portion and the ground portion by the connecting portion.

12. The antenna structure of claim 11, wherein the first resonation portion and the second resonation portion are substantially strip-shaped and perpendicularly extended from a distal end of the connecting portion along two opposite directions.

13. An antenna comprising:
a ground portion;
a feed portion extended from the ground portion and defining a cut with the ground portion;
a connecting portion;
a first resonation portion, the first resonation portion defining a first gap with the connecting portion and the feed portion, and obtaining a first working frequency band by adjusting dimensions of the first resonation gap and the cut; and
a second resonation portion, the second resonation portion defining a second gap with the connecting portion and the ground portion, and obtaining a second working frequency band by adjusting dimensions of the second resonation gap.

14. The antenna structure of claim 13, wherein the ground portion comprises two opposite first edges and two opposite second edges, the feed portion extends from one of the second edges.

15. The antenna structure of claim 14, wherein the feed portion comprises an extending section and a feed end, the extending section is formed by extending from one of the second edges for a first distance, the feed end is formed by extending from a distal end of the extending section along a direction perpendicular to the extending section for a second distance and parallel to the second edges.

16. The antenna structure of claim 15, wherein the connecting portion is formed by perpendicularly extending from one of the first edges for a third distance, the first resonation portion and the second resonation portion are connected to the ground portion and the ground portion by the connecting portion.

17. The antenna structure of claim 16, wherein the first resonation portion and the second resonation portion are substantially strip-shaped and perpendicularly extended from a distal end of the connecting portion along two opposite directions.
